(19) United States
(12) Patent Application Publication
(10) Pub. No.: US 2009/0310259 A1
(43) Pub. Date: Dec. 17, 2009

(54) Head, Head Suspension Assembly, and Disk Device Provided with the Same

(75) Inventor: Mitsunobu Hanyu, Hamura-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: KABUSHIKI KAISHA TOSHIBA, Tokyo (JP)

(21) Appl. No.: 12/349,416

(22) Filed: Jan. 6, 2009

(30) Foreign Application Priority Data
Jun. 12, 2008 (JP) 2008-154261

(51) Int. Cl. G11B 5/60

(52) U.S. Cl. 360/235.6; G9B/5.229

(57) ABSTRACT

According to one embodiment, a slider of a head comprises a negative-pressure cavity formed in a facing surface, a leading step portion situated on the upstream side of the negative-pressure cavity, a pair of side portions opposed to each other, a trailing step portion situated on the outflow side of the negative-pressure cavity, a pair of skirt portions extending in the first direction from the side portions toward the outflow end of the slider and being deeper than the side portions, and intermediate step portions extending continuously along the skirt portions outside the skirt portions with respect to the second direction and formed to be deeper than the skirt portions and shallower than the negative-pressure cavity.

### CROSS-REFERENCE TO RELATED APPLICATIONS

This application is based upon and claims the benefit of priority from Japanese Patent Application No. 2008-154261, filed Jun. 12, 2008, the entire contents of which are incorporated herein by reference.

### BACKGROUND

1. Field

One embodiment of the present invention relates to a head used in a disk device such as a magnetic disk device, a head suspension assembly provided with the head, and a disk device provided with the head suspension assembly.

2. Description of the Related Art

A disk device, e.g., a magnetic disk device, includes a magnetic disk, spindle motor, magnetic head, and carriage assembly. The magnetic disk is arranged in a case. The spindle motor supports and rotates the disk. The magnetic head writes and reads information to and from the disk. The carriage assembly supports the head for movement with respect to the disk. The carriage assembly includes a rockably supported arm and a suspension extending from the arm. The magnetic head is supported on an extended end of the suspension. The head includes a slider attached to the suspension and a head portion on the slider. The head portion is constructed including a reproducing element for reading and a recording element for writing.

The slider has a facing surface (air bearing surface (ABS)) that is opposed to a recording surface of the magnetic disk. A predetermined head load directed to a magnetic recording layer of the disk is applied to the slider by the suspension. When the magnetic disk device operates, air-flows are produced between the disk in rotation and the slider. Based on the principle of aerodynamic lubrication, a force (positive pressure) to fly the slider above the recording surface of the disk acts on the facing surface of the slider. By balancing this flying force with the head load, the slider is flown with a gap above the recording surface of the disk. There is a known disk device in which a negative-pressure cavity or a dynamic pressure producing groove is formed near the center of a facing surface of a slider in order to prevent variation of the flying height of the slider.

As described in, for example, Jpn. Pat. Appln. KOKAI Publication No. 2003-99910, the slider includes a negative-pressure groove formed at the central part of an ABS, a front pad portion provided on the inflow-end side of the slider, and a rear pad portion on the outflow-end side of the slider, and a magnetic head is provided on the rear pad portion.

A lubricant is applied thinly to a surface of a conventional magnetic disk in order to reduce abrasion that is caused by contact between a magnetic head and a disk interface. Although most of the lubricant adheres to the disk surface, a small portion of the lubricant may sometimes be separated from the disk surface and adhere to the facing surface of a slider. If the lubricant adheres to the slider, the deposit amount of the lubricant gradually increases. If a certain amount is exceeded, the lubricant drops from the slider onto the disk surface and adheres in lumps to the disk surface. If these lumps of the lubricant are formed on the disk surface, the magnetic head flies too high above the disk surface not to cause a so-called high flight as the magnetic head passes over the lumps. In some cases, therefore, the magnetic head cannot accurately write and read information to and from the disk surface.

In order to reduce the deposit amount of the lubricant, the slider is provided with intermediate steps that are formed individually on the opposite sides of the rear pad portion. These intermediate steps serve to reduce the difference in level between the rear pad portion and the negative-pressure groove, thereby reducing the amount of accumulation of the lubricant at the level-difference portion.

If the slider of this type is provided with the intermediate steps on the opposite sides of the rear pad portion, however, the production of the negative pressure is easily reduced, although the deposit amount of the lubricant is also reduced. This hinders suppression of variation of the flying height of the slider and lowers the reliability and stability.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary plan view showing an HOD according to a first embodiment of the invention;

FIG. 2 is an exemplary enlarged side view showing a magnetic head portion of the HDD;

FIG. 3 is an exemplary perspective view showing the disk-facing surface side of a slider of the magnetic head;

FIG. 4 is an exemplary plan view showing the disk-facing surface side of the slider;

FIG. 5 is an exemplary sectional view taken along line A-A of FIG. 4;

FIG. 6 is an exemplary conceptual diagram of air-flows between a disk surface and the slider;

FIG. 7 is an exemplary plan view showing a slider of a magnetic head without an intermediate step portion given as a comparative example;

FIG. 8 is an exemplary view showing flows of air outside a skirt portion and a side portion according to the comparative example;

FIG. 9 is an exemplary view showing flows of air outside a skirt portion and a side portion of the slider according to the first embodiment;

FIG. 10 is an exemplary plan view schematically showing the disk-facing surface side of a magnetic disk according to a second embodiment of the invention;

FIG. 11 is an exemplary plan view schematically showing the disk-facing surface side of a magnetic disk according to a third embodiment of the invention;

FIG. 12 is an exemplary plan view schematically showing the disk-facing surface side of a magnetic disk according to a fourth embodiment of the invention;

FIG. 13 is an exemplary plan view schematically showing the disk-facing surface side of a magnetic disk according to a fifth embodiment of the invention; and

FIG. 14 is an exemplary plan view schematically showing the disk-facing surface side of a magnetic disk according to a sixth embodiment of the invention.

### DETAILED DESCRIPTION

Various embodiments according to the invention will be described hereinafter with reference to the accompanying drawings. In general, according to one embodiment of the invention, a head comprises a slider which includes a facing surface opposed to a surface of a rotatable recording medium, an inflow-end face extending transversely to the facing surface, and an outflow-end face extending transversely to the facing surface and is configured to be flown by an air-flow which is produced between the recording medium surface and the facing surface as the recording medium rotates; and a head portion provided on the slider and configured to record and reproduce information to and from the recording medium. The facing surface of the slider comprises a first direction in the air-flow and a second direction perpendicular to the first direction. The slider comprises a negative-pressure cavity formed in the facing surface and configured to produce a negative pressure; a leading step portion projecting with respect to the negative-pressure cavity and situated on the upstream side of the negative-pressure cavity with respect to the air-flow; a pair of side portions projecting with respect to the negative-pressure cavity, extending in the first direction from the leading step portion toward an outflow end of the slider, and opposed to each other with a space therebetween in the second direction; a trailing step portion projecting with respect to the negative-pressure cavity, situated on the outflow side of the negative-pressure cavity with respect to the air-flow, and having a top surface opposed to the recording medium; a pair of skirt portions formed on the facing surface, projecting with respect to the negative-pressure cavity, extending in the first direction from the side portions toward the outflow end of the slider, and being deeper than the side portions; and intermediate step portions extending continuously along the skirt portions outside the skirt portions with respect to the second direction and formed to be deeper than the skirt portions and shallower than the negative-pressure cavity.

A first embodiment in which a disk device according to this invention is applied to a hard disk drive (HDD) will now be described in detail with reference to the accompanying drawings.

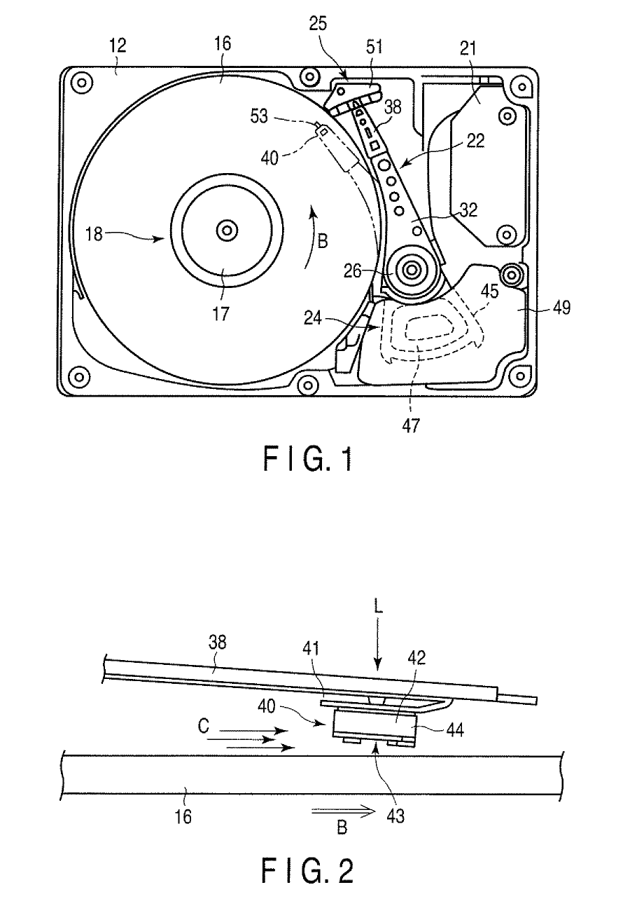

FIG. 1 shows the internal structure of the HDD with a top cover of its housing off. As shown in FIG. 1, the HDD includes a case 12 in the form of an open-topped rectangular box and a top cover (not shown). The top cover is fastened to the case by screws so as to close the top opening of the case.

The case 12 contains a magnetic disk 16, spindle motor 18, magnetic heads 40, carriage assembly 22, voice coil motor (VCM) 24, ramp load mechanism 25, board unit 21, etc. The magnetic disk 16 serves as a recording medium. The spindle motor 18 serves as a drive section that supports and rotates the disk. The magnetic heads write and read information to and from the disk. The carriage assembly 22 supports the heads for movement with respect to the disk 16. The VCM 24 rocks and positions the carriage assembly. The ramp load mechanism 25 holds the magnetic heads in a retracted position at a distance from the magnetic disk when the heads are moved to the outermost periphery of the disk. The board unit 21 includes a head IC and the like.

A printed circuit board (not shown) is screwed to the outer surface of a bottom wall of the case 12. The circuit board controls the operations of the spindle motor 18, VCM 24, and magnetic heads 40 through the board unit 21.

The magnetic disk 16 has magnetic recording layers on its upper and lower surfaces, individually. Further, a lubricant, such as oil, is spread to a thickness of about 1 nm on a surface of the magnetic disk 16. The disk 16 is fitted on a hub (not shown) of the spindle motor 18 and fixed on the hub by a clamp spring 17. If the motor 18 is driven, the disk 16 is rotated at a predetermined speed of, for example, 4,200 rpm in the direction of arrow B.

The carriage assembly 22 is provided with a bearing portion 26, which is fixed on the bottom wall of the case 12, and arms 32 that extend from the bearing portion. The arms 32 are situated parallel to the surfaces of the magnetic disk 16 and spaced apart from one another. Further, the arms 32 extend in the same direction from the bearing portion 26. The carriage assembly 22 is provided with suspensions 38 that are elastically deformable, elongated plates. Each suspension 38 is formed of a leaf spring, of which the proximal end is fixed to the distal end of its corresponding arm 32 by spot welding or adhesive bonding and which extends from the arm. Alternatively, each suspension 38 may be formed integrally with its corresponding arm 32. The arm 32 and the suspension 38 constitute a head suspension, and the head suspension and the magnetic heads 40 constitute a head suspension assembly.

As shown in FIG. 2, each magnetic head 40 includes a slider 42 substantially in the shape of a rectangular parallelepiped and a read/write head portion 44 on the slider. The head 40 is fixed to a gimbal spring 41 that is provided on the distal end portion of each suspension 38. Each magnetic head 40 is subjected to a head load L that is directed to a surface of the magnetic disk 16 by the elasticity of the suspension 38.

As shown in FIG. 1, the carriage assembly 22 includes a support frame 45 that extends from the bearing portion 26 oppositely from the arms 32. The support frame supports a voice coil 47 that constitutes a part of the VCM 24. The support frame 45 is molded from plastic and formed integrally on the outer periphery of the voice coil 47. The coil 47 is situated between a pair of yokes 49 that are fixed on the case 12 and, in conjunction with these yokes and a magnet (not shown) fixed to one of the yokes, constitutes the VCM 24. If the voice coil 47 is energized, the carriage assembly 22 rocks around the bearing portion 26, whereupon each magnetic head 40 is moved to and positioned in a region over a desired track of the magnetic disk 16.

The ramp load mechanism 25 includes a ramp 51 and tabs 53. The ramp 51 is provided on the bottom wall of the case 12 and located outside the magnetic disk 16. The tabs 53 extend individually from the respective distal ends of the suspensions 38. As the carriage assembly 22 rocks to its retracted position outside the disk 16, each tab 53 engages with a ramp surface on the ramp 51 and is then pulled up along the slope of the ramp surface, whereupon each magnetic head 40 is unloaded.

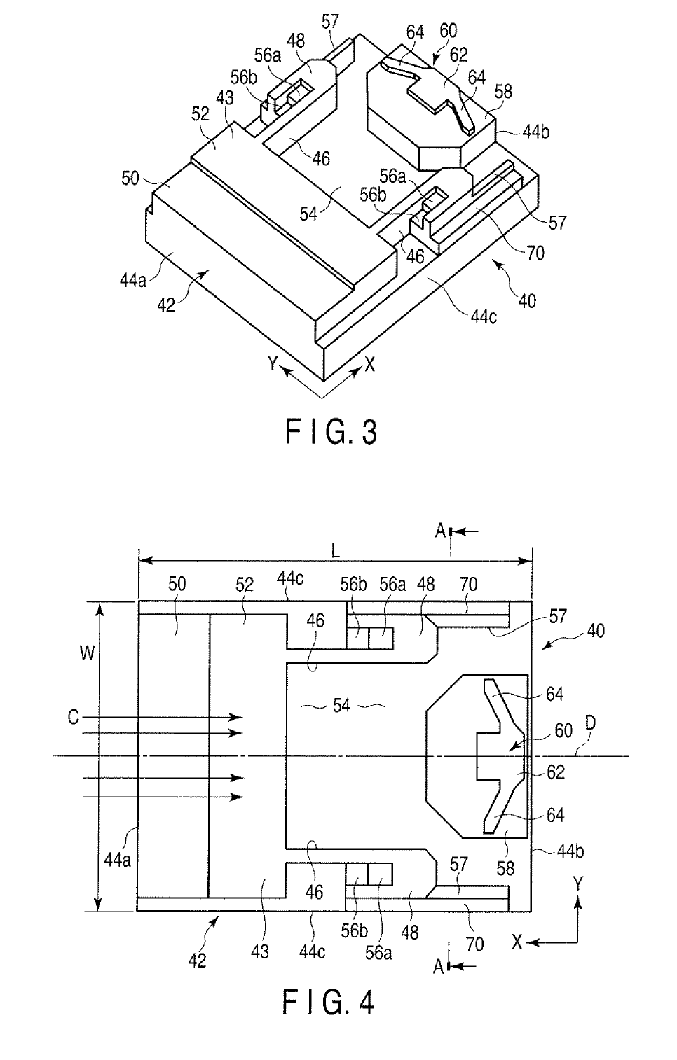

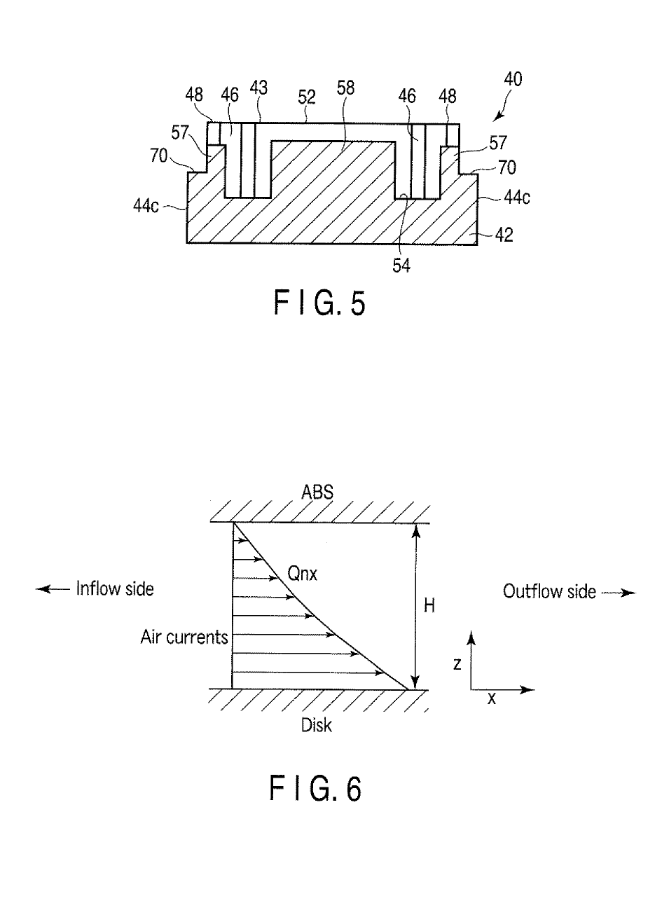

The following is a detailed description of a configuration of each magnetic head 40. FIG. 3 is a perspective view showing the slider of the magnetic head, FIG. 4 is a plan view of the slider, and FIG. 5 is a sectional view of the slider.

As shown in FIGS. 3 to 5, the magnetic head 40 includes the slider 42 that is substantially in the shape of a rectangular parallelepiped. The slider has a rectangular disk-facing surface (ABS) 43, an inflow-end face 44a, an outflow-end face 44b, and a pair of side faces 44c. The disk-facing surface 43 faces a surface of the magnetic disk 16. The inflow- and outflow-end faces 44a and 44b extend at right angles to the disk-facing surface. The side faces 44c extend between the end faces 44a and 44b and at right angles to the disk-facing surface.

The longitudinal direction of the disk-facing surface 43 is supposed to be a first direction X, and the transverse direction perpendicular thereto to be a second direction Y. The slider 42 is formed as a so-called femto slider, having a length L of 1.25 mm or less, e.g., 0.85 mm, in the first direction X and a width W of 1.00 mm or less, e.g., 0.70 mm, in the second direction Y.

The magnetic head 40 is constructed as a flying head, in which the slider 42 is flown by air-flows C (see FIG. 2) that are produced between the disk surface and the disk-facing surface 43 as the magnetic disk 16 rotates. When the HDD is operating, the disk-facing surface 43 of the slider 42 never fails to be opposed to the disk surface with a gap therebetween. The direction of the air-flows C is coincident with the direction of rotation B of the magnetic disk 16. The slider 42 is located so that the first direction X of the disk-facing surface 43 opposed to the surface of the disk 16 is substantially coincident with the direction of the air-flows C.

As shown in FIGS. 3 to 5, a negative-pressure cavity 54 is formed ranging from the substantial center of the disk-facing surface 43 to the outflow-end side. The cavity 54 is a recess that opens toward the outflow-end face 44b. The slider 42 is formed to be, for example, 0.23 mm thick, and the cavity 54 to be 800 to 1,500 nm, e.g., 1,500 nm, deep. The negative-pressure cavity 54 serves to produce a negative pressure on the central part of the disk-facing surface 43 at every feasible yaw angle for the HDD.

A substantially rectangular leading step portion 50 is formed on the inflow-side end portion of the disk-facing surface 43. The leading step portion 50 projects above the bottom surface of the negative-pressure cavity 54 so as to be one level lower than the disk-facing surface 43 and is situated on the inflow side of the cavity 54 with respect to the air-flows C.

The disk-facing surface 43 is formed with a pair of side portions 46 that extend along the side edges of the surface 43 and are opposed to each other with a space in the second direction Y between them. The side portions 46 protrude from the bottom surface of the negative-pressure cavity 54. The side portions 46 extend from the leading step portion 50 toward the downstream end of the slider 42. The leading step portion 50 and the pair of side portions 46 are located symmetrically with respect to a central axis D of the slider 42. As a whole, they are formed to be substantially U-shaped, closed on the upstream side and open to the downstream side. The leading step portion 50 and the side portions 46 define the negative-pressure cavity 54.

In order to maintain the pitch angle of the magnetic head 40, a leading pad 52 that utilizes an air film to support the slider 42 protrudes from the leading step portion 50. The leading pad 52 extends continuously throughout the area that covers the width of the leading step portion 50 along the second direction Y, and is formed in a position deviated on the downstream side from the inflow-end face 44a of the slider 42.

A side pad 48 is formed on each side portion 46 and leads to the leading pad 52. The pads 52 and 48 are formed substantially flat and form the disk-facing surface 43.

A first recess 56a and a second recess 56b are formed continuously in each side pad 48. The first and second recesses 56a and 56b open toward the inflow-side end of the disk-facing surface 43 as well as toward the magnetic disk surface. Each of the recesses 56a and 56b has a rectangular shape defined by a pair of side edges, which extend substantially parallel to the first direction Xr and a bottom edge, which connects the respective extended ends of the side edges and extends substantially parallel to the second direction Y. The second recess 56b is one level deeper than the first recess 56a.

The disk-facing surface 43 of the slider 42 is formed with a pair of skirt portions 57 that individually extend straight in the first direction X from the side portions 46 toward the outflow-side end of the slider. Each skirt portion 57 is formed to be deeper than each side portion 46 and projects above the bottom surface of the negative-pressure cavity 54. Each skirt portion 57 is, for example, 100 to 200 nm below the disk-facing surface 43.

An intermediate step portion 70 that extends continuously along each skirt portion 57 is formed outside the skirt portion with respect to the second direction Y. Each intermediate step portion 70 is formed to be deeper than each skirt portion 57 and shallower than the negative-pressure cavity 54. Each intermediate step portion 70 is, for example, 200 to 400 nm below the disk-facing surface 43. In the present embodiment, the intermediate step portions 70 extend continuously outside and along their corresponding skirt portions 57 and side portions 46. Each intermediate step portion 70 is flush with its corresponding side face 44c.

The slider 42 includes a trailing step portion 58 that is formed on the outflow-side end portion of the disk-facing surface 43 with respect to the air-flows C. The trailing step portion 58 projects above the bottom surface of the negative-pressure cavity 54, and the height of its projection is equal to that of the leading step portion 50. In other words, the trailing step portion 58 is formed so that its depth below the disk-facing surface 43 is equal to that of the leading step portion 50, that is, 50 to 250 nm, e.g., 100 nm. The trailing step portion 58 is situated on the downstream side of the negative-pressure cavity 54 with respect to the air-flows C and substantially in the center of the disk-facing surface 43 with respect to the second direction Y. Further, the trailing step portion 58 is slightly deviated from the outflow-end face 44b of the slider 42 toward the inflow-end face 44a.

As shown in FIGS. 3 to 5, the trailing step portion 58 is substantially in the shape of a rectangular parallelepiped, of which two corner portions on the upstream side are chamfered. The trailing step portion 58 has a top surface that faces the magnetic disk surface.

A trailing pad 60 that utilizes an air film to support the slider 42 protrudes from the top surface of the trailing step portion 58. The trailing pad 60 is formed flush with the leading pad 52 and the side pads 48 and its surface constitutes the disk-facing surface 43.

The trailing pad 60 includes a substantially rectangular base portion 62 and a pair of wing portions 64 that extend in the second direction Y from the base portion to opposite sides. On the trailing step portion 58, the base portion 62 is provided on the central axis D at the outflow-end side and situated substantially in the center with respect to the second direction Y. Each wing portion 64 extends in the first direction X from each end of the base portion 62 to the upstream-end side of the slider 42.

The head portion 44 of the magnetic head 40 includes a recording element and a reproducing element, which record and reproduce information to and from the magnetic disk 16. The reproducing and recording elements are embedded in the downstream end portion of the slider 42 with respect to the air-flows C. The reproducing and recording elements have a read/write gap (not shown) that is defined in the trailing pad 60.

According to the HDD and the head suspension assembly constructed in this manner, the magnetic head 40 is flown by the air-flows C that are produced between the disk surface and the disk-facing surface 43 as the magnetic disk 16 rotates. When the HDD is operating, therefore, the disk-facing surface 43 of the slider 42 never fails to be opposed to the disk surface with a gap therebetween. As shown in FIG. 2, the magnetic head 40 flies in an inclined posture such that the read/write gap of the head portion 44 is located closest to the disk surface.

Since the disk-facing surface 43 of the slider 42 is provided with the negative-pressure cavity 54, the magnetic head 40 can produce a negative pressure on the central part of the surface 43 at every feasible yaw angle for the HDD. Further, the shallow intermediate step portions 70 are provided outside the skirt portions 57 and the side portions 46 so that the gap between the slider and the surface of the magnetic disk 16 is narrowed. By doing this, flows of air outside the skirt portions 57 and the side portions 46 can be regulated to increase the flow rate. Thus, stagnation of air can be prevented, so that adhesion of the lubricant to the outside of the skirt portions 57 and the side portions 46 can be reduced.

The following is a description of a mechanism for the flow regulation. FIG. 6 is a conceptual diagram of the air-flows, and the following equation (1) is a formula for calculating a flow rate Q_{X} in the slider length direction (first direction X).

$${Q}_{x} = {\int }_{0}^{H} u d z = \frac{VH}{2} - \frac{{H}^{3}}{12 μ} \frac{\partial P}{\partial x}$$

where u, V, H, p, P and x are a speed function along the slider length, disk speed, gap between the disk surface and the ABS (disk-facing surface), viscosity coefficient of air, air film pressure, and slider length direction, respectively.

As seen from equation (1), the flow rate Q_{X} increases as the gap H is reduced if the disk speed V is constant, since H³ is present in the second term of equation (1). Thus, the flows of air outside the skirt portions 57 and the side portions 46 can be regulated to increase the flow rate by providing the shallow steps or intermediate step portions 70 outside the skirt portions 57 of the slider 42, thereby narrowing the gap H between the slider and the magnetic disk surface.

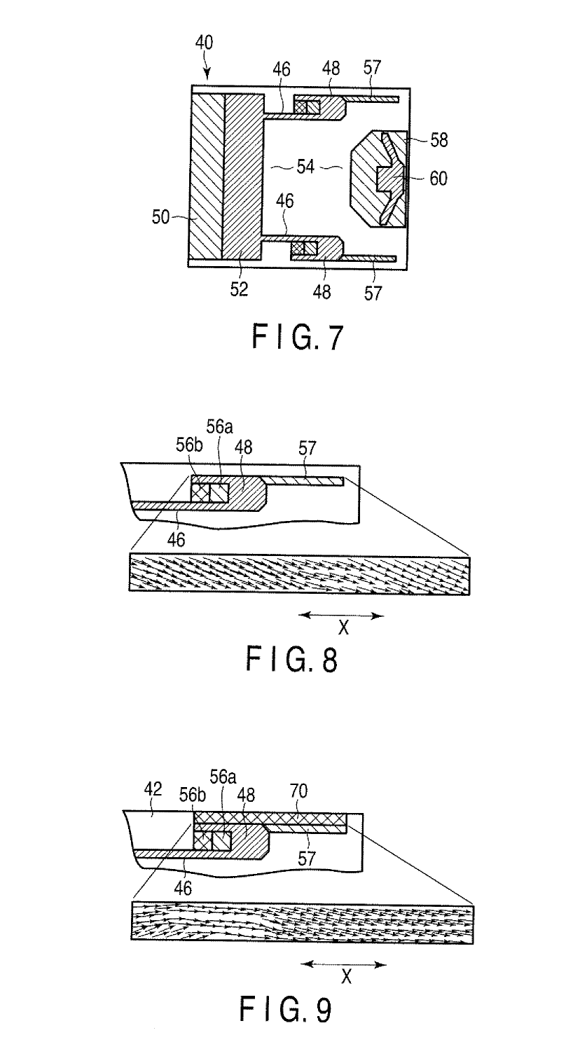

The inventor hereof prepared the slider according to the present embodiment and a slider according to a comparative example with no intermediate step portions outside skirt portions, as shown in FIG. 7, performed a flow rate analysis for these sliders, and compared the sliders for the flows of air outside the skirt portions and the side portions. FIG. 8 shows the flows of air in the slider according to the comparative example, and FIG. 9 shows those in the slider according to the present embodiment.

In the comparative example, as seen from FIG. 8, the flows of air outside a skirt portion 57 and a side portion 46 are all inclined with respect to the length of the slider (in the first direction X). In the slider 42 according to the present embodiment, as seen from FIG. 9, on the other hand, the flows of air at the intermediate step portions 70 outside the skirt portions 57 and the side portions 46 are substantially parallel to the slider length direction X, thus proving a flow regulation effect.

By this flow regulation effect of the intermediate step portions 70, the flows of air outside the skirt portions 57 and the side portions 46 can be regulated to increase the flow rate, so that adhesion of the lubricant can be reduced. Thus, a high flight of the slider that is attributable to dropping of the lubricant can be prevented, so that the magnetic head can accurately write and read information. Since no intermediate step portions are provided on either side of a trailing step portion, moreover, variation of the flying height of the slider can be suppressed to improve the reliability and stability without reducing the load.

In consequence, there may be obtained a head of improved reliability and stability, capable of reducing adhesion of a lubricant to a slider, a head suspension assembly provided with the head, and a disk device.

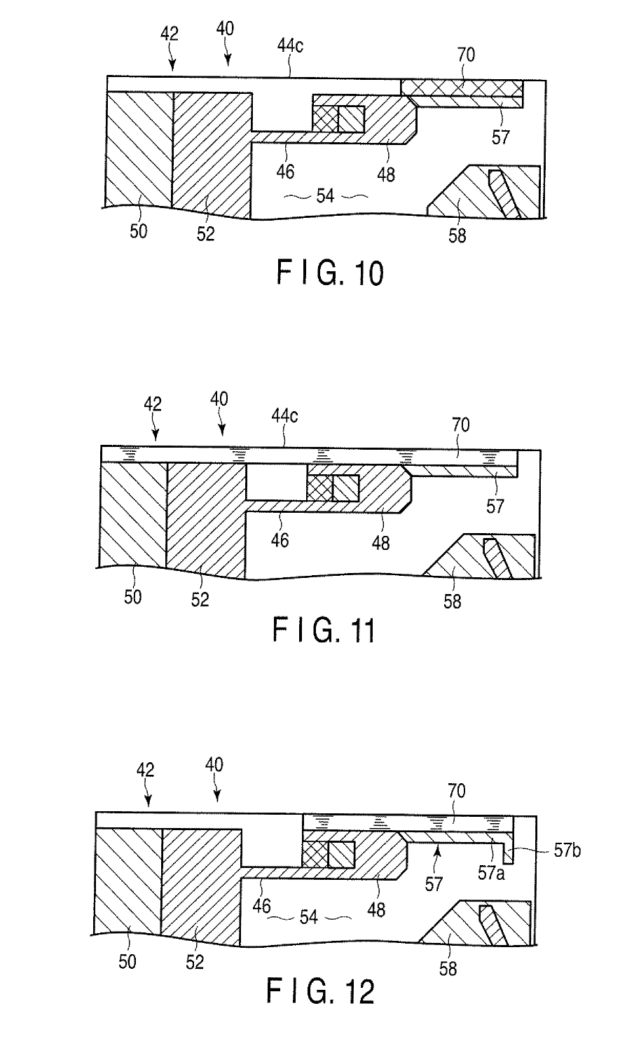

FIG. 10 schematically shows a magnetic head 40 of a disk device according to a second embodiment of the invention. According to the present embodiment, an intermediate step portion 70 of a slider 42 is formed outside and along a skirt portion 57 only.

In a magnetic head 40 of a disk device according to a third embodiment of the invention, as shown in FIG. 11, each intermediate step portion 70 of a slider 42 is formed outside and along a skirt portion 57, a side portion 46, and a leading step portion 50 so as to extend substantially throughout the length of each side edge of the slider 42.

In a magnetic head 40 of a disk device according to a fourth embodiment of the invention, as shown in FIG. 12, each skirt portion 57 of a slider 42 includes a first portion 57a, which extends in a first direction from a side portion 46, and a second portion 57b, which extends in a second direction from an extended end of the first portion toward a trailing step portion 58. An intermediate step portion 70 is located outside and along the first portion 57a.

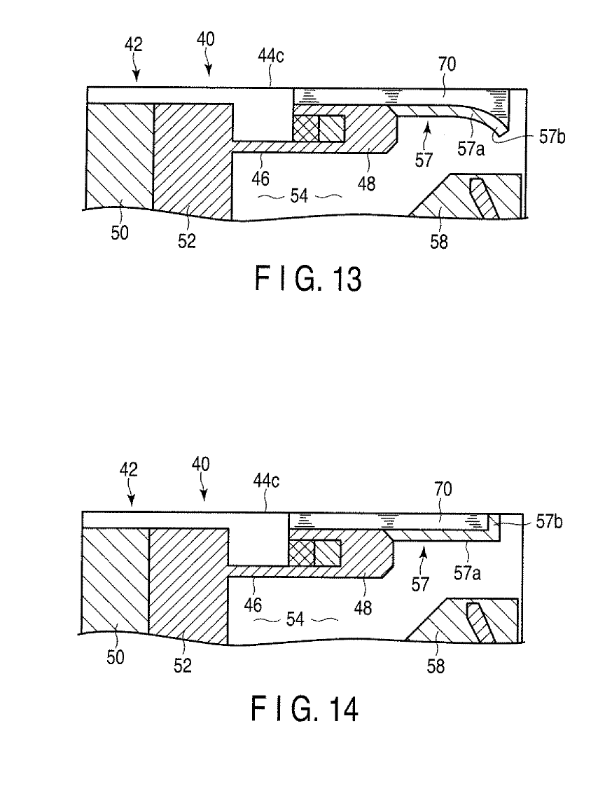

In a magnetic head 40 of a disk device according to a fifth embodiment of the invention, as shown in FIG. 13, each skirt portion 57 of a slider 42 includes a first portion 57a, which extends in a first direction from a side portion 46, and a second portion 57b, which extends curvedly from an extended end of the first portion toward a trailing step portion 58. An intermediate step portion 70 is located outside and along the first and second portions 57a and 57b.

In a magnetic head 40 of a disk device according to a sixth embodiment of the invention, as shown in FIG. 14, each skirt portion 57 of a slider 42 includes a first portion 57a, which extends in a first direction from a side portion 46, and a second portion 57b, which extends oppositely to a trailing step portion 58 in a second direction from an extended end of the first portion. An intermediate step portion 70 is located outside and along the first and second portions 57a and 57b.

In the second to sixth embodiments, other configurations of the slider are the same as those of the foregoing first embodiment, so that like reference numbers are used to designate like portions, and a detailed description thereof is omitted. Also in the second to sixth embodiments, moreover, the flow rate can be increased by regulating the flows of air by means of the intermediate step portions, and the same functions and effects of the first embodiment can be obtained.

The present invention is not limited directly to the embodiments described above, and in carrying out the invention, its components may be embodied in modified forms without departing from the scope or spirit of the invention. Further, various inventions may be made by suitably combining a plurality of components described in connection with the foregoing embodiments. For example, some of the components according to the foregoing embodiments may be omitted. Furthermore, components according to different embodiments may be combined as required.

The shapes, dimensions, etc., of the leading step portion, trailing step portion, intermediate step portions, and pads of the slider are not limited to the embodiments described herein and may be varied as required. This invention is not limited to femto sliders and may also be applied to pico sliders, pemto sliders, or any other larger sliders. The number of magnetic disks may be increased without being limited to one.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fail within the scope and spirit of the invention.

What is claimed is:

1. A head comprising:
a slider which includes a facing surface opposed to a surface of a rotatable recording medium, an inflow-end face extending transversely to the facing surface, and an outflow-end face extending transversely to the facing surface and is configured to be flown by an air-flow which is produced between the recording medium surface and the facing surface as the recording medium rotates; and
a head portion provided on the slider and configured to record and reproduce information to and from the recording medium,
the facing surface of the slider comprising a first direction in the air-flow and a second direction perpendicular to the first direction,
the slider comprising a negative-pressure cavity formed in the facing surface and configured to produce a negative pressure; a leading step portion projecting with respect to the negative-pressure cavity and situated on the upstream side of the negative-pressure cavity with respect to the air-flow; a pair of side portions projecting with respect to the negative-pressure cavity, extending in the first direction from the leading step portion toward an outflow end of the slider, and opposed to each other with a space therebetween in the second direction; a trailing step portion projecting with respect to the negative-pressure cavity, situated on the outflow side of the negative-pressure cavity with respect to the air-flow, and having a top surface opposed to the recording medium; a pair of skirt portions formed on the facing surface, projecting with respect to the negative-pressure cavity, extending in the first direction from the side portions toward the outflow end of the slider, and being deeper than the side portions; and intermediate step portions extending continuously along the skirt portions outside the skirt portions with respect to the second direction and formed to be deeper than the skirt portions and shallower than the negative-pressure cavity.

2. The head of claim 1, wherein the intermediate step portions extend continuously outside and along the skirt portions and the side portions, respectively.

3. The head of claim 1, wherein the intermediate step portions extend continuously outside and along the skirt portions, the side portions, and the leading step portion, respectively.

4. The head of claim 1, wherein each of the skirt portions includes a first portion extending in a first direction from the side portion, and a second portion extending in the second direction from an extended end of the first portion toward the trailing step portion, and the intermediate step portion is located outside and along the first portion.

5. The head of claim 1, wherein each of the skirt portions includes a first portion extending in the first direction from the side portion, and a second portion extending curvedly from an extended end of the first portion toward the trailing step portion, and the intermediate step portion is located outside and along the first and second portions.

6. The head of claim 1, wherein each of the skirt portions includes a first portion extending in the first direction from the side portion, and a second portion extending oppositely to the trailing step portion in the second direction, and the intermediate step portion is located outside and along the first and second portions.

7. The head of claim 1, wherein the slider has opposite side faces which extend transversely to the facing surface in the first direction between the inflow- and the outflow-end faces, and the intermediate step portions are flush with the side faces, respectively.

8. A head suspension assembly used in a disk device which includes a disk shaped recording medium and a drive section configured to support and rotate the recording medium, the head suspension assembly comprising:
a head including a slider, which has a facing surface opposed to a surface of the recording medium, an inflow-end face extending transversely to the facing surface, and an outflow-end face extending transversely to the facing surface and is configured to be flown by an air-flow which is produced between the recording medium surface and the facing surface as the recording medium rotates, and a head portion provided on the slider and configured to record and reproduce information to and from the recording medium; and
a head suspension configured to support the head for movement with respect to the recording medium and apply a head load directed toward the surface of the recording medium to the head,
the facing surface of the slider having a first direction along the air-flow and a second direction perpendicular to the first direction,
the slider comprising a negative-pressure cavity formed in the facing surface and configured to produce a negative pressure; a leading step portion projecting with respect to the negative-pressure cavity and situated on the upstream side of the negative-pressure cavity with respect to the air-flow; a pair of side portions projecting with respect to the negative-pressure cavity, extending in the first direction from the leading step portion toward an outflow end of the slider, and opposed to each other with a space therebetween in the second direction; a trailing step portion projecting with respect to the negative-pressure cavity, situated on the outflow side of the negative-pressure cavity with respect to the air-flow, and having a top surface opposed to the recording medium; a pair of skirt portions formed on the facing surface, projecting with respect to the negative-pressure cavity, extending in the first direction from the side portions toward the outflow end of the slider, and being deeper than the side portions; and intermediate step portions extending continuously along the skirt portions outside the skirt portions with respect to the second direction and formed to be deeper than the skirt portions and shallower than the negative-pressure cavity.

9. A disk device comprising:
a disk shaped recording medium;
a drive section configured to support and rotate the recording medium;
a head including a slider, which has a facing surface opposed to a surface of the recording medium, an inflow-end face extending transversely to the facing surface, and an outflow-end face extending transversely to the facing surface and is configured to be flown by an air-flow which is produced between the recording medium surface and the facing surface as the recording medium rotates, and a head portion provided on the slider and configured to record and reproduce information to and from the recording medium; and
a head suspension configured to support the head for movement with respect to the recording medium and apply a head load directed toward the surface of the recording medium to the head,
the facing surface of the slider having a first direction along the air-flow and a second direction perpendicular to the first direction,
the slider comprising a negative-pressure cavity formed in the facing surface and configured to produce a negative pressure; a leading step portion projecting with respect to the negative-pressure cavity and situated on the upstream side of the negative-pressure cavity with respect to the air-flow; a pair of side portions projecting with respect to the negative-pressure cavity, extending in the first direction from the leading step portion toward an outflow end of the slider, and opposed to each other with a space therebetween in the second direction; a trailing step portion projecting with respect to the negative-pressure cavity, situated on the outflow side of the negative-pressure cavity with respect to the air-flow, and having a top surface opposed to the recording medium; a pair of skirt portions formed on the facing surface, projecting with respect to the negative-pressure cavity, extending in the first direction from the side portions toward the outflow end of the slider, and being deeper than the side portions; and intermediate step portions extending continuously along the skirt portions outside the skirt portions with respect to the second direction and formed to be deeper than the skirt portions and shallower than the negative-pressure cavity.
